(19) United States
(12) Patent Application Publication
(10) Pub. No.: US 2026/0159002 A1
(43) Pub. Date: Jun. 11, 2026

(54) VEHICLE CONSOLE HAVING BIN WITH DOOR AND CHARGING TRAY

(71) Applicant: Ford Global Technologies, LLC, Dearborn, MI (US)

(72) Inventors: Michael Canty, Bloomfield Hills, MI (US); Rairam Almeida, Salvador (BR); Eduardo Bezerra, Saline, MI (US); Luiz Roberto Junior, Salvador (BR); Paul Repp, Plymouth, MI (US); Bradley Berner, Dearborn, MI (US)

(73) Assignee: Ford Global Technologies, LLC, Dearborn, MI (US)

(21) Appl. No.: 18/976,840

(22) Filed: Dec. 11, 2024

(51) Int. Cl. B60R 7/04; B60N 2/75; B60R 11/00; B60R 11/02; H02J 7/00; H02J 50/00; H02J 50/10; H02J 50/40; H02J 50/90

(52) U.S. Cl. CPC B60R 7/04; B60N 2/793; B60R 11/0241; H02J 7/731; H02J 50/005; H02J 50/10; H02J 50/90; B60R 2011/007; H02J 50/402

(57) ABSTRACT

A console for a vehicle has a housing defining a console having a storage bin with an access opening. A door is configured to cover the access opening of the bin. A charging tray is provided on a top side of the door. A hinge mechanism is operatively coupling the door to the housing to allow the door to rotate between an open position exposing the access opening and a closed position covering the access opening. One or more charging modules are located on the charging tray for inductively charging one or more electronic devices.

### FIELD OF THE DISCLOSURE

The present disclosure generally relates to inductive charging of chargeable devices in a vehicle, and more particularly relates to a bin having a deployable tray with inductive charging for charging chargeable electronic devices onboard a vehicle.

### BACKGROUND OF THE DISCLOSURE

Motor vehicles are commonly equipped with various charging ports for charging mobile electronic devices such as phones, for example, which have one or more rechargeable batteries that are electrically chargeable. Vehicles have been equipped with wireless charging systems that employ inductive charging, such as a fixed inductive charging tray which has induction charging circuitry that inductively couples with inductive charging circuitry in the chargeable mobile electronic device being charged. It may be desirable to provide for a versatile bin and charging assembly that provides efficient inductive charging for use on a motor vehicle.

### SUMMARY OF THE DISCLOSURE

According to a first aspect of the present disclosure, a console for a vehicle has a housing defining a console having a storage bin with an access opening. A door is configured to cover the access opening of the bin. A charging tray is provided on a top side of the door. A hinge mechanism is operatively coupling the door to the housing to allow the door to rotate between an open position exposing the access opening and a closed position covering the access opening. One or more charging modules are located on the charging tray for inductively charging one or more electronic devices.

Embodiments of the first aspect of the present disclosure can include any one or a combination of the following features:
the door is configured to rotate by an angle in a range of 0 to 90 degrees;
the door is configured to rotate by an angle in a range of 0 to 55 degrees;
the hinge mechanism comprises two friction hinges aligned on a pivot axis;
a latch for holding the cover in the closed position;
the latch comprises a first magnet;
a second magnet configured to attract an electronic device to operably couple the electronic device with the one or more inductive chargers;
the charging tray is part of the door and has a bottom and a plurality of upstanding walls defining a holding area on the tray;
the console comprises a center console in a vehicle; and
a device retainer for retaining one or more electrical devices on the charging tray.

According to a second aspect of the present disclosure, a center console assembly for a vehicle has a housing defining a console having a storage bin with an access opening. A door is configured to cover the access opening of the bin. A charging tray is provided on a top side of the door. A hinge mechanism is operatively coupling the door to the housing to allow the door to rotate between an open position exposing the access opening and a closed position covering the access opening. One or more charging modules are located on the charging tray for inductively charging one or more electronic devices.

Embodiments of the second aspect of the present disclosure can include any one or a combination of the following features:
the door is configured to rotate by an angle in a range of 0 to 90 degrees;
the door is configured to rotate by an angle in a range of 0 to 55 degrees;
the friction hinge mechanism comprises two friction hinges aligned on a pivot axis;
a latch for holding the cover in the closed position;
the latch comprises a first magnet;
a second magnet configured to attract an electronic device to operably couple the electronic device with the one or more inductive chargers;
the charging tray is part of the door and has a bottom and a plurality of upstanding walls defining a holding area on the tray;
the storage bin is forward of a storage compartment; and
a device retainer for retaining one or more electrical devices on the charging tray.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper perspective view of a front portion of a passenger compartment of a motor vehicle having a center console assembly with a bin and a cover door having an inductive charging tray;

FIG. 2 is an upper front perspective view of the center console assembly illustrating the bin with the door in the closed position;

FIG. 3 is an enlarged perspective view of a portion of the center console assembly illustrating a pair of chargeable devices located in the tray on the door with the door in the closed position;

FIG. 3A is a cross-sectional view taken through longitudinal axis in FIG. 3 illustrating the door and the tray in the closed position;

FIG. 4 is an upper front perspective view of a portion of the center console illustrating the door in an open position with chargeable devices located in the tray;

FIG. 4A is a cross-section taken through line IVA-IVA of FIG. 4 illustrating the door in the open position;

FIG. 5 is a front upper perspective view of the center console with the door in the open position and having a single chargeable device in the tray;

FIG. 6 is a cross-section taken through the line VI-VI further illustrating the door in a partially open position; and

FIG. 7 is a block diagram illustrating the inductive coupling and charging of a chargeable mobile device.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

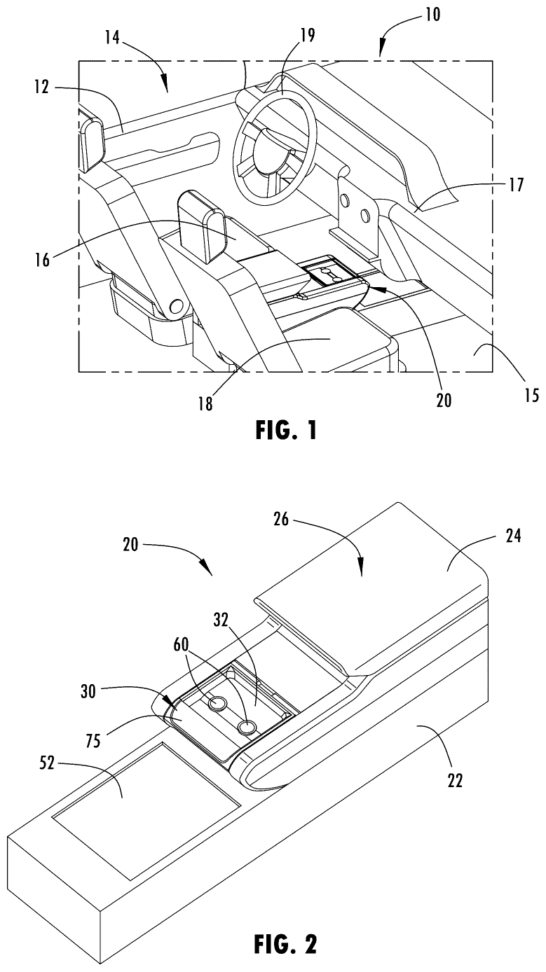

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a console assembly having a door with a charging tray for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a passenger compartment 14 of a motor vehicle 10 is generally illustrated equipped with a vehicle console 20 configured as a center console having a bin 40 with a rotatable door 30 that has an inductive charging tray 35 provided thereon, according to one embodiment. The vehicle 10 may be a motor vehicle, for example, a wheeled motor vehicle which may include a car, a truck, a van, a bus, an SUV, etc. The passenger compartment 14 is generally defined by a body 12 which may include body panels, doors, windows, a floor and a roof. The passenger compartment 14 is generally equipped with a seating arrangement having one or more seats such as a driver's seat 16 for seating a driver of the motor vehicle 10 and other seats for seating one or more passengers. It should be appreciated that the motor vehicle 10 may include any of a number of seats 16, including a front row of seating and one or more rear rows of seating. It should further be appreciated that one or more rotatable doors 30 with inductive charging trays 35 provided thereon may be employed on one or more consoles on the motor vehicle 10, particularly in one or more locations that are readily accessible to one or more occupants seated in the motor vehicle 10.

The passenger compartment 14 is further illustrated having a steering wheel 19 generally located forward of the driver's seat 16 and a dashboard 17 that extends laterally along a front portion of the passenger compartment 14 forward of the steering wheel 19 between lateral left and right sides of the motor vehicle 10. A vehicle console configured as a center console 20 is shown centrally located in a space that generally separates the driver's seat 16 from a right side passenger seat 18 in the front row of seating. The center console 20 generally extends vehicle forward to a location rearward of and approaching or below the rearward side of the dashboard 17 as shown according to one example.

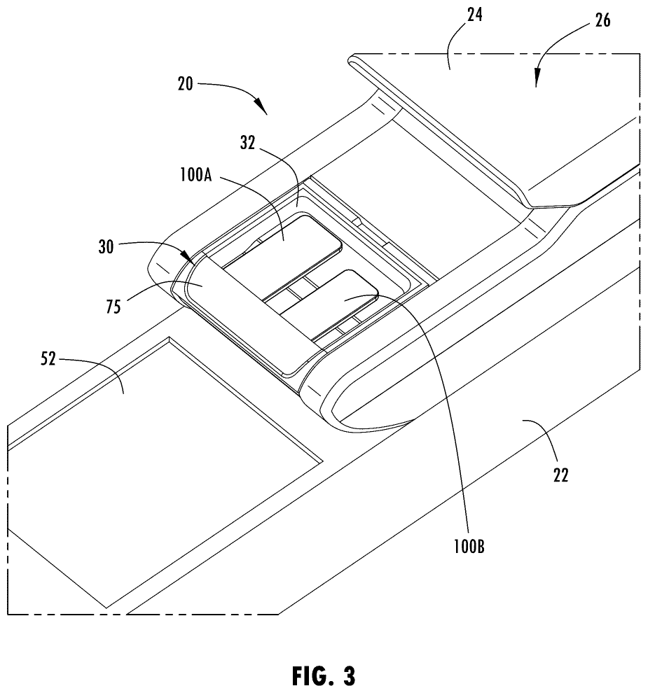

The center console 20 includes a housing 22 which is generally supported on an underlying vehicle floor 15. The housing 22 may be directly fastened or attached to the floor 15 or may be connected indirectly to the floor 15 via a base, for example. The center console 20 generally extends within the space between the driver's seat 16 and passenger seat 18 and includes a main storage compartment 26 in the mid to rear portion of the center console 20 which has a top access opening that may be covered by an armrest lid 24 in the closed position. It should be appreciated that the armrest lid 24 may be pivotally connected to a top rear end of the housing 22 to enable the armrest lid 24 to rotate between the closed position shown in FIG. 2 and an open position which exposes the top access opening to allow access to the main storage compartment 26. The armrest lid 24 may include a cushion and is generally configured to support the arm of a driver or passenger seated in the driver's seat 16 or passenger seat 18.

The center console 20 further includes a storage bin 40 located forward of the main storage compartment 26 and the armrest lid 24. The storage bin 40 may be configured as a media bin configured to receive one or more portable electronic devices such as one or more mobile phones for storage therein and electric charging of one or more batteries associated with each portable electronic device. The media bin 40 generally includes a bottom 57 and sidewalls 47 defining the shape and size of the bin 40 and may be equipped with one or more power and communication ports such as one or more USB ports 38 e.g., USB-A and/or USB-C ports. As such, one or more electrically chargeable electronic devices stored within the bin 40 may be connected to the USB ports 38 to receive electrical energy for charging the chargeable devices associated with the electronic devices and to provide data communication for the electronic devices.

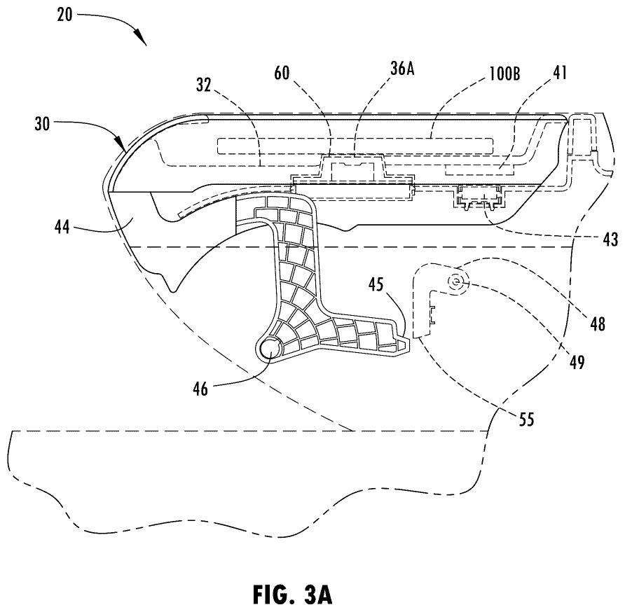

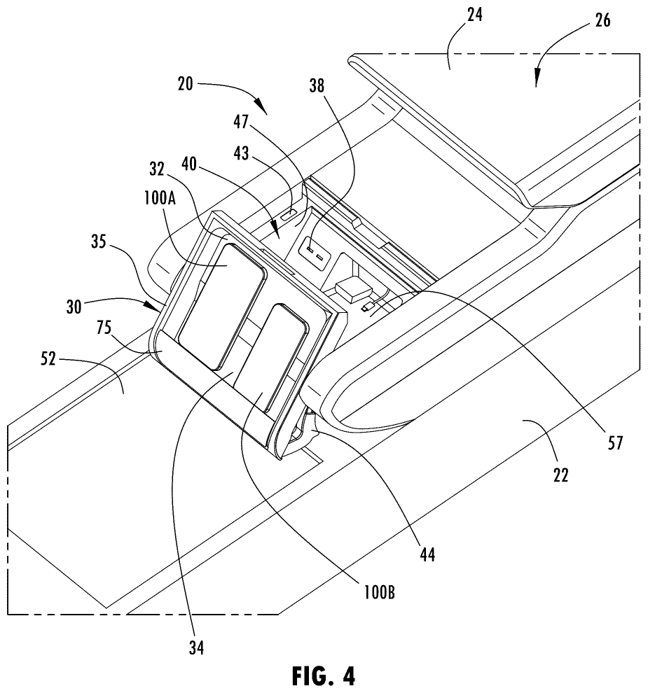

The bin 40 is equipped with a rotatable door 30 configured to cover a top access opening of the bin 40. The door 30 has an inductive charging tray 35 provided on the top side. The cover 30 is rotatable between a closed position oriented substantially horizontal and covering the top access opening as shown in FIG. 3, and an open position exposing the top access opening as shown in FIG. 4. The bin door 30 is configured to serve as a cover to close the open top end of the bin 40 and also includes the tray 35 provided on the top surface thereof configured to receive one or more portable electronic devices, such as mobile phones 100A and 100B that may be inductively charged when positioned in the tray 35. The tray 35 is part of the door 30, according to one embodiment, and generally includes a floor and upstanding sidewalls as shown in a rectangular configuration. The tray 35 may be integrally formed as part of the door 30 or may be a separate part assembled onto the door 30, according to other embodiments. The tray 35 also includes a pair of charging devices 60 which may include inductive charging circuitry to charge the portable electronic devices 100A and 100B.

The bin door 30 includes a pair of support arms 44 on opposite left and right lateral sides to support the door 30 which rotates about a pivot rod 46 that extends laterally within the center console. The pivot rod 46 and support arms 44 support the door 30 which is configured to rotate through an angle θ in the range of 0 -90 degrees, and more particularly in the range of 0-55 degrees, between the open and closed positions. The door 30 has a latching magnet attractant such as a steel plate 41 located in a lower forward area of the door 30 and configured to magnetically align with and attract to a magnet 43 in the housing 22 in the closed position. The magnet 43 and the steel plate 41 align to form a latch to latch the door 30 in the closed position and to release the door 30 under sufficient force to allow the door 30 to rotate to the open position.

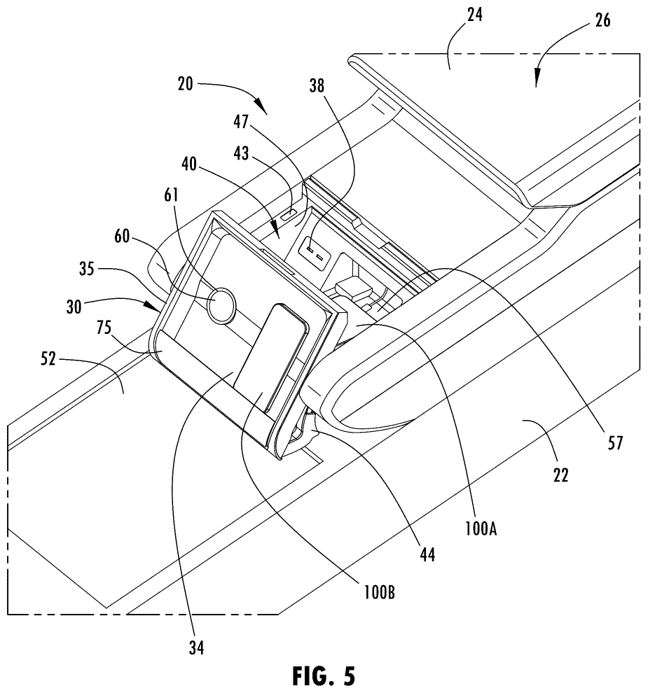

The console assembly 20 also has an inertial lock assembly that includes a projection lip 45 on the end of each L-shaped arm 44 that is configured to matingly engage an end 55 of an inertial lever 48 that rotates about a pivot rod 49. When the vehicle 10 slows at a sufficiently fast rate, the inertial lever 48 having a mass rotates vehicle forward about pivot rod 49 to lock end 55 onto projection lip 45 as shown in FIG. 6 to thereby prevent opening of the door 30.

The portable charging device 60 includes inductive charging circuitry and a magnet 61 extending around a perimeter thereof that is configured and used to align and magnetically attach to a chargeable mobile electronic device having inductive charging circuitry. In the example shown, a disk shaped charging pad is disposed between the mobile chargeable electronic device 100A and the inductive charging device 60. However, it should be appreciated that the tray 35 may be utilized with an alternate, disk-shaped charging pad configuration, according to other embodiments.

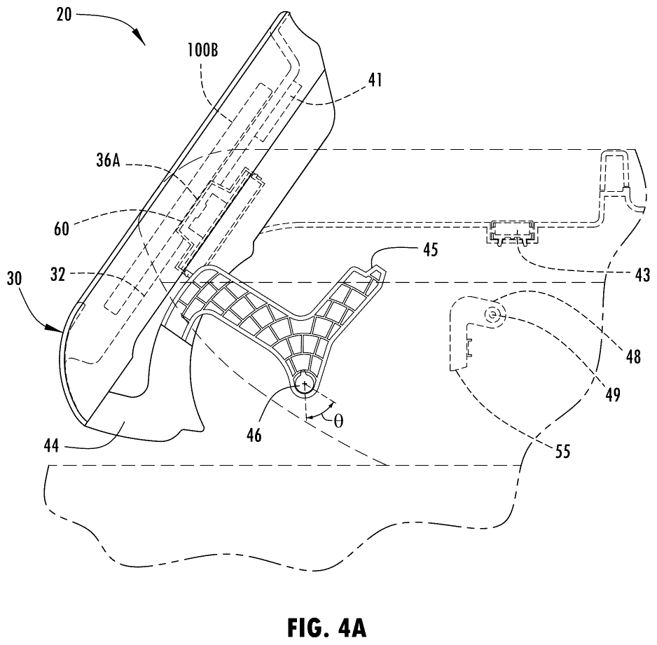

As seen in FIG. 5, the inductive charging devices 60 are shown on the tray 35. The tray 35 is further illustrated having a retainer 75. The retainer 75 may be a retaining wall configured to extend upward and hold one more mobile electronic devices 100A and 100B. As illustrated in FIG. 5, the retainer 75 may retain a bottom end of each mobile electronic device. It should be appreciated that one or more retainers or retention devices may be provided on the top, bottom or sides of the chargeable mobile electronic devices 100A and 100B that are to be held on the cover 30.

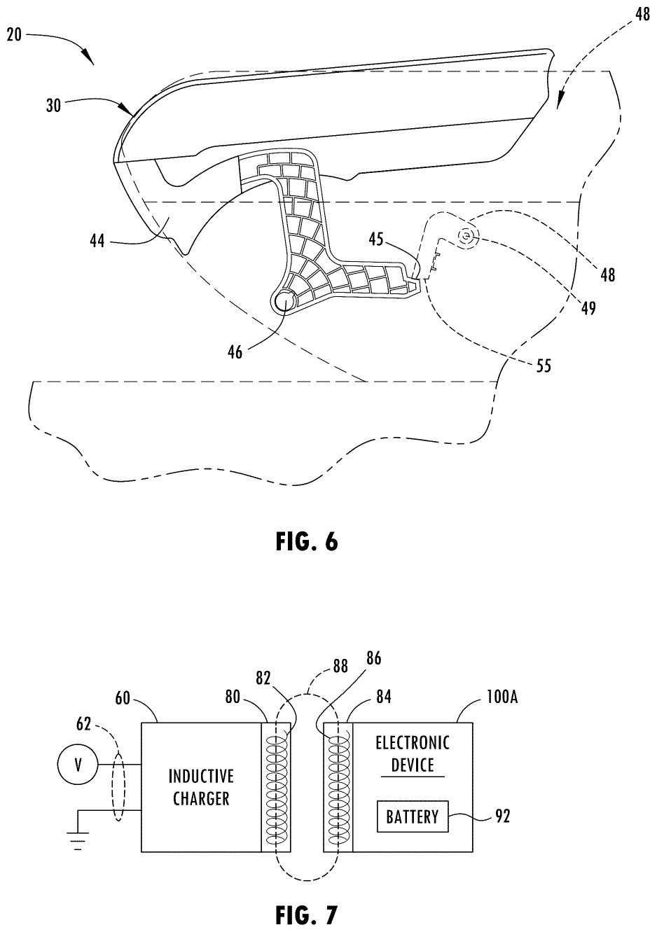

Referring to FIG. 7, the inductive charging device 60 is shown having inductive charging circuitry 80 which may include inductive coils 82. The mobile chargeable electronic device 100A is also shown having inductive charging circuitry 84 which may likewise include inductive coils 86. When the mobile chargeable electronic device 100 is positioned sufficiently close to the inductive charger device 60 (e.g., within 10 cm), the inductive charging circuitry 80 in the inductive charger 60 may be inductively coupled to the inductive charging circuitry 84 in the mobile electronic device 100A to enable the inductive charger device 60 to charge one or more batteries 92 in the mobile electronic device 100A. Typically, this may be achieved by coupling the inductive coils 82 of the inductive charger device 60 with the inductive coils 86 of the mobile electronic device 100A to create an inductive field 88. The inductive charger device 60 receives power from a voltage supply V and is coupled to ground through the power cable 62. The power cable 62 may be electrically coupled to the vehicle battery and ground via circuitry such as the plug-in connector 65, for example, a USB connector.

Accordingly, the vehicle console 20 advantageously provides for a rotatable door 30 with an inductive charging tray 35 rotatably positioned on a bin 40. Wireless inductive charging on the tray 35 is provided in a manner that allows the door 30 to move between open and closed positions to expose or cover the bin 40. The door 30 may rotate between open and closed positions without interrupting inductive charging of one or more electronic devices 100A and 100B on the tray 35.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A console for a vehicle, the console comprising:
a housing defining a console having a storage bin with an access opening;
a door configured to cover the access opening of the bin;
a charging tray provided on a top side of the door;
a hinge mechanism operatively coupling the door to the housing to allow the door to rotate between an open position exposing the access opening and a closed position covering the access opening; and
one or more charging modules located on the charging tray for inductively charging one or more electronic devices.

2. The console of claim 1, wherein the door is configured to rotate by an angle in a range of 0 to 90 degrees.

3. The console of claim 1, wherein the door is configured to rotate by an angle in a range of 0 to 55 degrees.

4. The console of claim 3, wherein the hinge mechanism comprises two friction hinges aligned on a pivot axis.

5. The console of claim 1, further comprising a latch for holding the door in the closed position.

6. The console of claim 5, wherein the latch comprises a first magnet.

7. The console of claim 1, further comprising a second magnet configured to attract an electronic device to operably couple the electronic device with the one or more inductive chargers.

8. The console of claim 1, wherein the charging tray is part of the door and has a bottom and a plurality of upstanding walls defining a holding area on the tray.

9. The console of claim 1, wherein the console comprises a center console in a vehicle.

10. The console of claim 1, further comprising a device retainer for retaining one or more electrical devices on the charging tray.

11. A center console for a vehicle, the center console comprising:
a housing defining a console having a storage bin with an access opening;
a door configured to cover the access opening of the bin;
a charging tray provided on a top side of the door;
a hinge mechanism operatively coupling the door to the housing to allow the door to rotate between an open position exposing the access opening and a closed position covering the access opening; and
one or more charging modules located on the charging tray for inductively charging one or more electronic devices.

12. The center console of claim 11, wherein the door is configured to rotate by an angle in a range of 0 to 90 degrees.

13. The center console of claim 11, wherein the door is configured to rotate by an angle in a range of 0 to 55 degrees.

14. The center console of claim 13, wherein the friction hinge mechanism comprises two friction hinges aligned on a pivot axis.

15. The center console of claim 14, further comprising a latch for holding the door in the closed position.

16. The center console of claim 15, wherein the latch comprises a first magnet.

17. The center console of claim 11, further comprising a second magnet configured to attract an electronic device to operably couple the electronic device with the one or more inductive chargers.

18. The center console of claim 11, wherein the charging tray is part of the door and has a bottom and a plurality of upstanding walls defining a holding area on the tray.

19. The center console of claim 11, wherein the storage bin is forward of a storage compartment.

20. The center console of claim 11, further comprising a device retainer for retaining one or more electrical devices on the charging tray.
